(19) United States
(12) Patent Application Publication
(10) Pub. No.: US 2017/0276980 A1
(43) Pub. Date: Sep. 28, 2017

(54) HEADLAMP FOR VEHICLES

(71) Applicant: Hella KGaA Hueck & Co., Lippstadt (DE)

(72) Inventors: Rainer Kauschke, Lippstadt (DE); Carsten Wilks, Lippstadt (DE); Christian Schmidt, Paderborn (DE)

(21) Appl. No.: 15/506,136

(22) PCT Filed: Aug. 19, 2015
(86) PCT No.: PCT/EP2015/069008

§ 371 Date: Feb. 23, 2017

(30) Foreign Application Priority Data
Sep. 23, 2014 (DE) 102014113700.0

(51) Int. Cl. G02F 1/1335; F21V 7/04; F21V 7/00; B60Q 1/14

(52) U.S. Cl. CPC G02F 1/1336; B60Q 1/14; F21V 7/04; F21V 7/0025; G02F 1/13

(57) ABSTRACT

A headlamp for vehicles having a light source, a lens unit and a liquid crystal shutter arranged between the light source and the lens unit. The liquid crystal shutter includes a multitude of surface areas that can each be controlled to switch the respective surface areas to a transparent or a non-transparent state so that a given light distribution pattern is generated. A polarizing reflector is assigned to the light source, so that a linearly polarized light beam is reflected in the direction of the liquid crystal shutter.

### CROSS REFERENCE

This application claims priority to PCT Patent Application No. PCT/EP2015/069008, filed 19 Aug. 2015, which itself claims priority to German Application No. 10 2014 113700.0, filed 23 Sept. 2014, the entirety of both of which are hereby incorporated by reference.

### FIELD OF THE INVENTION

The invention relates to a headlamp for vehicles having a light source, having a lens unit and having a liquid crystal shutter comprising a multitude of surface areas, each being electrically controllable to change the respective surface areas to a transparent or a non-transparent state, so that a given light distribution pattern is generated.

### BACKGROUND OF THE INVENTION

From DE 10 2008 008 484 A1, a headlamp for vehicles is known, which works according to the projection principle. The headlamp has a light source, a lens unit and a shutter, the shutter being arranged in the focal plane of the lens. To generate a light distribution pattern suitable for the current traffic situation, the shutter is embodied as a liquid crystal shutter comprising a multitude of electrically controllable pixels. By means of these, the state of the surface areas of the liquid crystal shutter can be changed from a transparent to a non-transparent state, so that, for example, a dazzle-free high-beam light distribution pattern can be generated, which has a non-dazzling area preventing the traffic object in the traffic area in front of the vehicle from being dazzled. When electric voltage is applied, the orientation of the liquid crystals in the pixels of the liquid crystal shutter changes. To be able to distinctly switch the surface areas from the transparent to the non-transparent state, it is necessary that polarized light hits the liquid crystal shutter. To this end, it is known that standard polarizing filters are arranged between the light source and the liquid crystal shutter. In such polarizing filters, it is disadvantageous that a share of the light with a non-usable polarization direction is transformed into heat, which in turn leads to efficiency losses.

It is therefore the task of the present invention to further develop a headlamp for vehicles comprising a liquid crystal shutter so that the liquid crystal shutter is employed in an effective manner for the generation of various light distribution patterns and particularly to increase efficiency.

According to the invention, a polarizing reflector having dual function is provided. On the one hand, it allows a bundling of the light beam via its curved reflector surfaces to generate a concentrated luminous intensity distribution in the area of the liquid crystal shutter, which is then projected via the lens unit. On the other hand, the polarizing reflector is arranged relative to the light source, respectively the polarizing reflector is formed so that a linear, polarized light beam is reflected on the reflector surfaces of the polarizing reflector toward the liquid crystal shutter. Advantageously, a polarizing filter can either be dispensed with, or its thermal load will be significantly reduced. Due to this, the headlamp has a compact design. By using LEDs, the generation of infrared radiation is minimal, which in turn additionally relieves the thermal load of the liquid crystal shutter.

According to a preferred embodiment of the invention, the polarizing reflector is arranged relative to the light source in a manner, that the light beams emitted by the light source hit different reflector surfaces of the polarizing reflector under a Brewster angle and that they are reflected by it in the direction of the liquid crystal shutter. Advantageously, a degree of polarization of 100% of the reflected light beam is achieved. Therefore, the polarizing reflector allows the focusing and polarization of the light beam. By focusing the light beams, a concentrated luminous intensity distribution is achieved in the plane of the liquid crystal shutter, thus increasing the efficiency of the headlamp. The maximum of light distribution is increased. On the liquid crystal shutter, only relatively little light beam per solid angle segment needs to be switched in the non-transparent state.

The luminous intensity distribution is preferably concentrated centrally in the horizontal and vertical sections to achieve the maximum luminous intensities in the center of the light distribution pattern.

According to a further development of the invention, the polarizing reflector is onion-shaped, so that a concentrated and focused light beam can be emitted in the direction of the liquid crystal shutter.

According to a further development of the invention, the polarizing reflector is embodied in a transparent or partially transparent manner, so that a first partial light beam is polarized and reflected and a second partial light beam is not polarized and passes through. The second light beam, which passes through the polarizing reflector, is reflected by a second reflector, so that the second partial light beam which passes by the liquid crystal shutter can be used to generate a basic light distribution pattern. The second light beam, being partially polarized, which has passed through the polarizing reflector, effects an increase in efficiency, as both polarized parts of the light beam are used. The basic light distribution pattern is preferably a static basic light distribution pattern being superimposed by the dynamic light distribution pattern generated by means of the liquid crystal shutter.

According to a further development of the invention, a polarizing beam splitter is arranged between the polarizing reflector and the liquid crystal shutter, wherein a further partial light beam of the light source which is directly radiated in the direction of the liquid crystal shutter, i.e. without a previous reflection by the polarizing reflector, is split into a first polarized light beam being directly directed toward the liquid crystal shutter and into a second polarized light beam being deflected to a further reflector, from which the second polarized light beam can contribute to the generation of the light distribution pattern. Preferably, a quarter-wave layer is integrated in the polarizing beam splitter, so that the second polarized light beam is rotated in its polarization direction and can then also hit the liquid crystal shutter.

Alternatively, the quarter-wave layer can also be applied to a further reflector. Advantageously, the efficiency of the headlamp can be further increased.

According to a further development of the invention, several dish-shaped polarizing reflectors can be arranged at right angles relative to an optical axis, wherein the polarizing reflectors are embodied in an at least partially transparent manner. Advantageously, a relatively large light beam can be directed toward the liquid crystal shutter in a space-saving manner.

According to a further development of the invention, the light source is arranged relative to the polarizing reflector so that due to the angle of incidence 4% to 70%, preferably 8% of the light beam is reflected on the reflector surfaces. By this means, 8% of the light beam can be polarized to 100% while maintaining the Brewster angle. The polarization share can be further increased to an advantageous 40% to 70% by means of interference resp. polarizing coatings. In addition to linear polarization shares, circular polarization is also utilized.

According to a further development of the invention, the liquid crystal shutter is controlled depending on sensor data provided by a traffic space detect unit (camera) so that a non-dazzling area of the light distribution pattern always overlaps with a traffic object in traffic space not to be dazzled. By this means, a dazzle-free high beam light distribution pattern can for example be generated, in which the traffic space is largely illuminated without a further traffic object being dazzled, for example a vehicle driving ahead or an oncoming vehicle.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a schematic representation of a headlamp according to a first embodiment.

FIG. 2 is a schematic representation of a headlamp according to a second embodiment.

FIG. 3 is a schematic representation of a headlamp according to a third embodiment.

FIG. 4 is a schematic representation of a headlamp according to a fourth embodiment.

FIG. 5 is a schematic representation of a headlamp according to a fifth embodiment.

FIG. 6 is a schematic representation of a headlamp according to a sixth embodiment.

### DETAILED DESCRIPTION OF THE DRAWINGS

A headlamp can be employed for the generation of a dazzle-free high beam resp. a permanent high beam or a marker light or a display function in front of the vehicle. Where applicable, the variants of the headlamp according to the invention described below can be complemented by a light module serving the generation of the basic light distribution pattern.

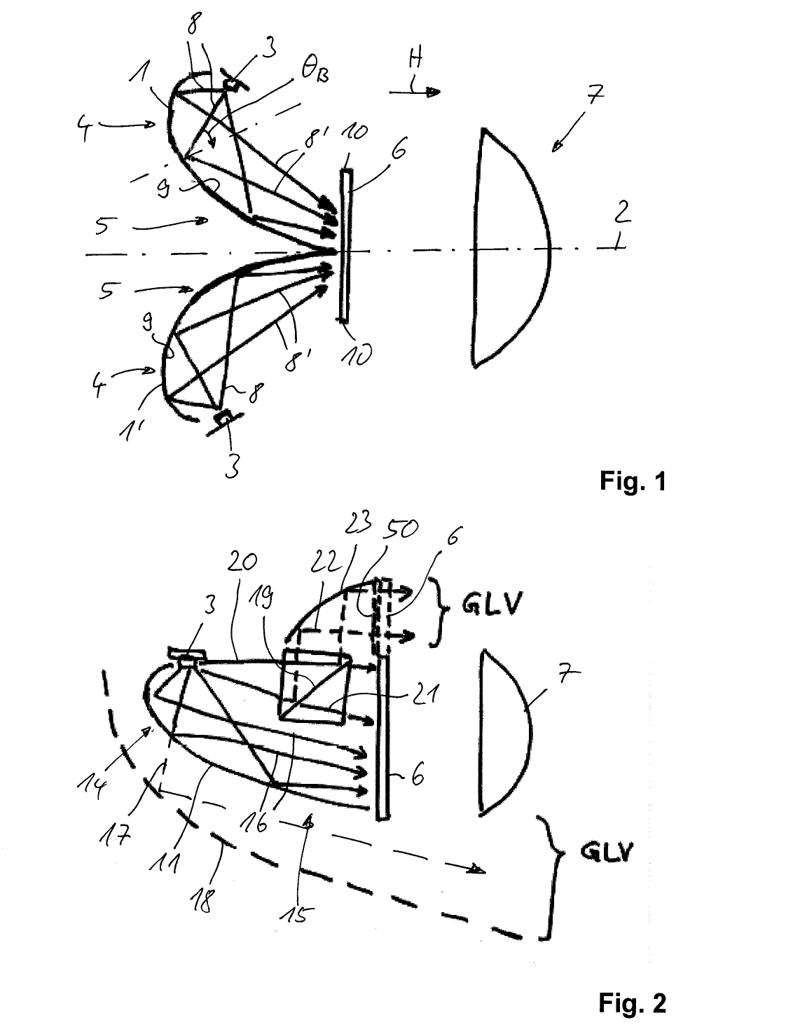

According to a first embodiment of the invention according to FIG. 1, the headlamp has two onion-shaped polarizing reflectors 1, 1′ being symmetrically arranged relative to an optical axis 2. The polarizing reflectors 1, 1′ are ach assigned to a light source 3 being arranged at an acute angle oriented against a main beam direction H of the headlamp. In an area close to the light source 3, the polarizing reflectors 1, 1′ each have a first curved section 4 with a relatively large curvature, and in an area distant to the light source 3, they have a second curved section 5 with a relatively small curvature arranged. The second curved sections 5 of the polarizing reflectors 1, 1′ converge in the main beam direction H.

A liquid crystal shutter 6 is arranged at a distance, preferably at a short distance, to the polarizing reflectors 1, 1′ and in front of them in the main beam direction H. This liquid crystal shutter 6 is embodied in a plate-shaped manner and extends perpendicularly to the optical axis 2. The liquid crystal shutter 6 is preferably arranged in a focal plane of a lens unit 7 being arranged in front of the former in the main beam direction H. The liquid crystal shutter 6 is therefore arranged between the polarizing reflector 1, 1′, and the lens unit 7. In an exemplary manner, the lens unit 7 can be embodied as a plano-convex lens.

In an exemplary manner, the light source 3 can be embodied as an LED-light source. The polarizing reflector 1, 1′ is arranged relative to the light source 3 so that a light beam radiated from the light source 3 hits a reflector surface 9 of the polarizing reflector 1, 1′ essentially under a Brewster-angle θ_{b}. By means of the polarizing reflector 1, 1′, the light beam 8 is reflected in a linear, polarized manner in the direction of the liquid crystal shutter 6. Only the part of the light is reflected which is polarized in a perpendicular manner relative to the plane of incidence. The reflected polarized light beam 8′ lies in a range between 4% and 70%, preferably 8% of the light beam 8 hitting the polarizing reflector 1, 1′.

The liquid crystal shutter 6 is embodied as a liquid crystal plate having a multitude of electrically controllable surface areas resp. pixels. These surface areas can be changed from a transparent to a non-transparent state. The liquid crystal shutter 6 is for example controlled depending on sensor signals of a traffic space detect unit (CCD-camera) so that a light distribution pattern with a dazzle-free area is generated, which overlaps a traffic object in traffic space. By local variation of the non-dazzling area, a dazzle-free high-beam light distribution pattern can for example be generated, which ensures that a traffic object driving ahead or an oncoming traffic object is not dazzled.

By a respective control of the liquid crystal shutter, freely programmable light distribution patterns can be generated, which can be varied depending on the speed, using a traffic space detect unit, a navigation system, or street topography data.

As can be seen in FIG. 1, the polarized light beam 8′ being polarized in a perpendicular manner relative to the drawing plane is reflected onto the liquid crystal shutter 6 in a focused manner. By this means, a concentrated luminous intensity distribution occurs in the region of the liquid crystal shutter 6, which is projected onto the traffic space via the lens unit 7.

The light sources 3 are arranged at a larger distance to the optical axis 2 than edge regions 10 of the liquid crystal shutter 6.

According to a second embodiment of the headlamp following FIG. 2 the light source 3 is arranged in a perpendicular orientation relative to the optical axis 2. A polarizing reflector 11 is assigned to the light source 3, which comprises a first curved section 14 and a second curved section 15, wherein the curvature of the reflector surface of the first curved section 14 is larger than the curvature of the reflector surface of the second curved section 14. The first curved section 14 has a stronger curvature than the first curved section 4 of the polarizing reflector 1, 1′ according to the first embodiment of the invention. The polarizing reflector 11 is embodied in a transparent manner, so that not only—as in the first embodiment of the invention—a first partial light beam 16 is reflected as a polarized light beam in the direction of the liquid crystal shutter 6, but so that in addition a second partial light beam 17 of the light emitted by the light source 3 penetrates the polarizing reflector 11 and is then reflected by a second reflector 18. The second partial light beam 17 passes by the liquid crystal shutter by means of the second reflector 18 and can serve to generate a basic light distribution pattern GLV. This basic light distribution pattern GLV is static and does not change while the headlamp is operated. In contrast to this, only part of the first partial light beam 16 is let through for the generation for example of the dazzle-free high beam light distribution pattern, where appropriate. This is a dynamic light distribution pattern being dependent on the current traffic situation.

Identical component parts and component part functions of the different exemplary embodiments receive identical reference numbers.

In addition, a polarizing beam splitter 19 is arranged between the light source 3 and the liquid crystal shutter 6, respectively, the polarizing beam splitter 19 is embodied as a polarizing cube beam splitter.

By this means a further, third partial light beam 20 of the light source 3 being emitted directly in the direction of the liquid crystal shutter 6, is split into a first polarized light beam 21 which is directly directed onto the liquid crystal shutter 6. The third partial light beam 20 is split into a second polarized light beam 24, being redirected at right angles to a further reflector 23. In an exemplary manner, a quarter wave layer 50 can be arranged on the incident light side of the liquid crystal shutter 6, so that the second polarized light beam 22 is rotated in its polarization direction before in hits the liquid crystal shutter 6, see dotted extension in FIG. 2. Alternatively, the quarter-wave layer can be applied to a further reflector 23.

Alternatively, the second polarized light beam 22 can also be used for the generation of a basic light distribution pattern GLV, when the second polarized light beam 22 does not hit the liquid crystal shutter 6.

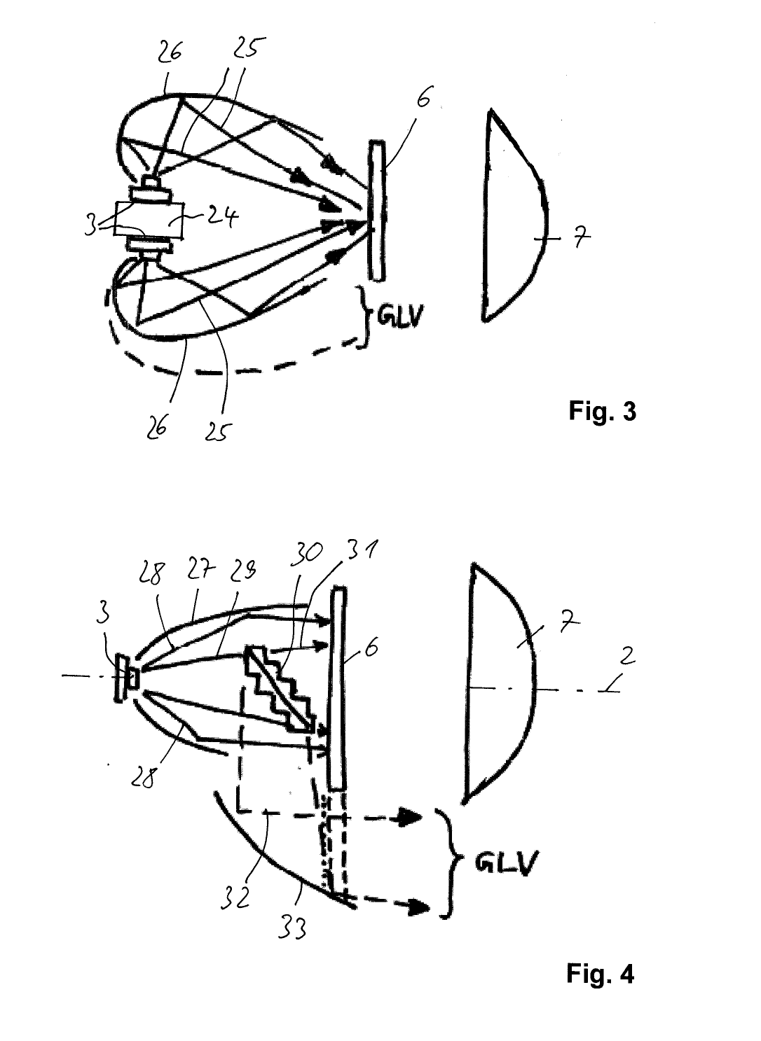

According to a further embodiment of the invention according to FIG. 3, two light sources 3 can also be arranged on the inside of a common heatsink 24 and each direct a light beam 25 on the polarizing reflectors 26 being symmetrically arranged relative to one another. The two polarizing reflectors 26 are each embodied in an onion-shaped manner, so that the light beam 25 is concentrated in the direction of the liquid crystal shutter 6. In an exemplary embodiment, the projecting lens unit 7 is embodied as a plano-convex lens. Alternatively, it can also be embodied as a biconvex or aspherical lens—which also applies to the other embodiments.

According to a fourth embodiment of the invention according to FIG. 4, a tube-shaped polarizing reflector 27 is provided, to which a light source 3 is assigned, which is oriented in the main beam direction H and which runs along the optical axis 2. A first partial light beam 28 is reflected on the reflector surfaces of the polarizing reflector 27 in the direction of the liquid crystal shutter 6. A second partial light beam 29 which does not hit the reflector surfaces of the polarizing reflector 27, but which is radiated directly in the direction of the liquid crystal shutter 6, hits a stepped polarizing beam splitter 30.

A first polarized light beam 31 is directly directed onto the liquid crystal shutter 6. A second polarized light beam 32 is redirected at right angles in the direction of a further reflector 33 on which the second polarized light beam 32 is redirected to the main beam direction H and can be used for the generation of the basic light distribution pattern GLV. In this case, the second polarized light beam 32 does not hit the liquid crystal shutter 6. Alternatively, the liquid crystal shutter 6 can also be embodied in an extended manner (shown as a dotted line in FIG. 4), so that the second polarized light beam 32 can be used for the dynamic light distribution pattern, as in the second exemplary embodiment.

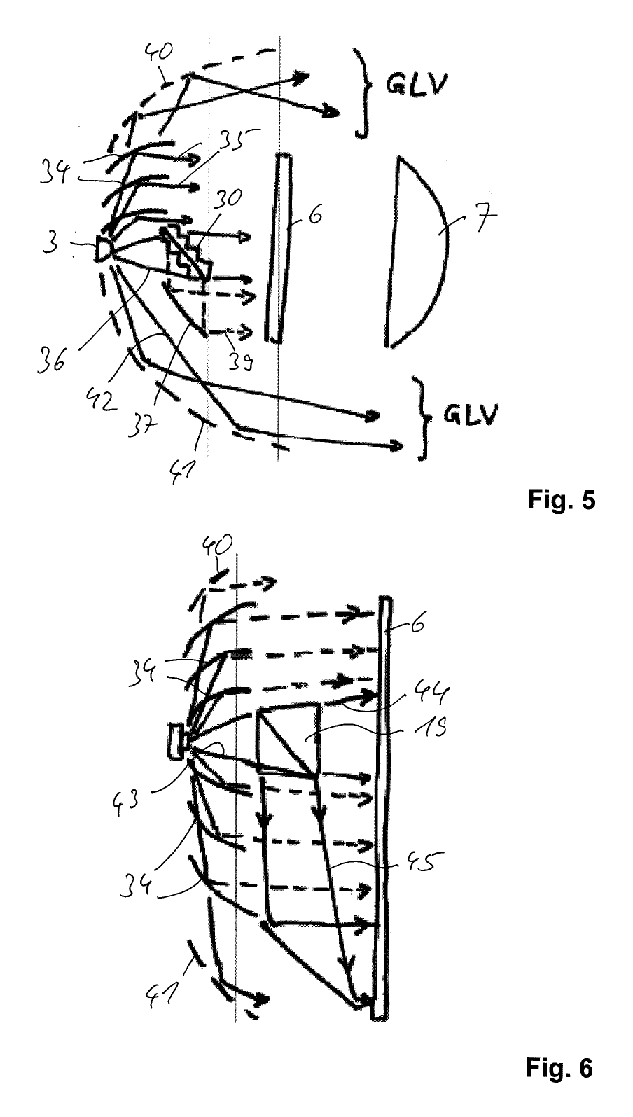

According to a fifth embodiment of the invention according to FIG. 5, a headlamp has a number of polarizing reflectors 34 which are arranged at right angles to the optical axis 2 in a staggered manner, each being embodied in a transparent manner. The polarizing reflectors 34 are therefore arranged in a dish-shaped manner. The dishes of the polarizing reflectors 34 allow the reflection of a polarized light beam 35 in the direction of the liquid crystal shutter 6. The light beam 36 directly radiated in the direction of the liquid crystal shutter 6 is partially let through by the stepped polarizing beam splitter 30 and is partially reflected to a further reflector 37, from which the polarized light beam 39 hits the liquid crystal shutter 6. The light beam let through by the liquid crystal shutter 6 is received by the lens unit 7 and projected according to the given light distribution pattern. Additional reflectors 40, 41 allow the use of a partial light beam 42 emitted under a large angle of beam spread which can be used to generate the basic light distribution pattern. Herein, the light is guided past the liquid crystal shutter 6.

According to a further embodiment of the invention according to FIG. 6, the onion-shaped polarizing reflectors 34 can also be arranged on opposite sides. The partial light beam 43 directly hitting the liquid crystal shutter 6 is divided by means of the polarizing beam splitter 19. A first polarized light beam 44 and a second polarized light beam 45 can therefore be used for the generation of the given light distribution pattern.

The LCD displays are each optionally cooled by a fan which is not represented.

The characteristics mentioned above can be applied on their own or in any combination. The described embodiments are not to be understood as an exhaustive list, but instead they are examples for the description of the invention.

List of Reference Signs

| | |
|---|---|
| 1, 1′ | Polarizing reflectors |
| 2 | Optical axis |
| 3 | Light source |
| 4 | Curved section |
| 5 | Curved section |
| 6 | Liquid crystal shutter |
| 7 | Lens unit |
| 8, 8′ | Light beam |
| 9 | Reflector surface |
| 10 | Edge regions |
| 11 | Polarizing reflector |
| 14 | 1st curved section |
| 15 | 2nd curved section |
| 16 | 1st partial light beam |
| 17 | 2nd partial light beam |
| 18 | Reflector |
| 19 | Polarizing beam splitter |
| 20 | Partial light beam |
| 21 | First polarized light beam |
| 22 | Second polarized light beam |
| 23 | Reflector |
| 24 | Heatsink |
| 25 | Light beam |
| 26 | Polarizing reflector |
| 27 | Polarizing reflector |
| 28 | Partial light beam |
| 29 | Partial light beam |
| 30 | Polarizing beam splitter |
| 31 | Polarized light beam |
| 32 | Polarized light beam |
| 33 | Reflector |
| 34 | Polarizing reflectors |
| 35 | Light beam |
| 36 | Light beam |
| 37 | Reflector |
| 39 | Polarized light beam |
| 40 | Reflector |
| 41 | Reflector |
| 42 | Partial light beam |
| 43 | Partial light beam |
| 44 | First polarized light beam |
| 45 | Second polarized light beam |
| 50 | Quarter-wave layer |
| H | Main beam direction |
| Θ_{b} | Brewster angle |
| GLV | Basic light distribution pattern |

1. A headlamp for vehicles comprising:
a light source;
a lens unit and
a liquid crystal shutter arranged between the light source and the lens unit
a polarizing reflector assigned to the light source, so that a linearly polarized light beam is reflected in direction of the liquid crystal shutter;
wherein the liquid crystal shutter comprising a multitude of surface areas that can each be controlled to switch the respective surface areas to a transparent or a non-transparent state so that a given light distribution pattern is generated.

2. The headlamp according to claim 1, wherein the polarizing reflector has several reflector surfaces being arranged relative to the light source in a manner that light beams emitted by the light source hit the reflector surfaces under a Brewster angle (Θb).

3. The headlamp according to claim 1 wherein the polarizing reflector is embodied in an onion-shaped manner and that the light source is arranged perpendicular to a main beam direction (H) of the headlamp or at an acute angle against the main beam direction (H).

4. The headlamp according to claim 1, wherein the polarizing reflector is embodied in a transparent or partially transparent manner, so that a first partial light beam is let through as a polarized light beam in the direction of the liquid crystal shutter and a second partial light beam is let through as an unpolarized light beam in the direction of a second reflector on which the second partial light beam is reflected past the liquid crystal shutter for the generation of a static basic light distribution pattern (GVL).

5. The headlamp according to claim 1, wherein a polarizing beam splitter is arranged between the polarizing reflector and the liquid crystal shutter, which divides a further partial light beam of the light source into a first polarized light beam which is directed directly to the liquid crystal shutter, and a second polarized light beam which is redirected to the liquid crystal shutter via a further reflector and a quarter-wave layer.

6. The headlamp according to claim 5, wherein the quarter-wave layer is integrated in the further reflector.

7. The headlamp according to claim 5, wherein the polarizing beam splitter is embodied in a stepped manner.

8. The headlamp according to claim 1, wherein several dishes of the polarizing reflectors can be arranged at right angles relative to an optical axis in a staggered manner, the polarizing reflectors being embodied in an at least partially transparent manner.

9. The headlamp according to claim 1, wherein the light source is arranged relative to the polarizing reflector so that due to the angle of incidence 4% to 70%, preferably 8% of the light beam is reflected on the reflector surfaces of the polarizing reflector.

10. The headlamp according to claim 1, wherein pixels of the liquid crystal shutter can be controlled depending on sensor data provided by a traffic space detect unit to generate the given light distribution pattern comprising a non-dazzling area in which a further traffic object is present.
